(19) United States
(12) Patent Application Publication
(10) Pub. No.: US 2015/0241560 A1
(43) Pub. Date: Aug. 27, 2015

(54) APPARATUS AND METHOD FOR PROVIDING TRAFFIC CONTROL SERVICE

(71) Applicant: ELECTRONICS AND TELECOMMUNICATIONS RESEARCH INSTITUTE, Daejeon (KR)

(72) Inventors: Byung-Gil LEE, Daejeon (KR); Byung-Doo KIM, Daejeon (KR); Do-Hyeung KIM, Daejeon (KR); Joong-Yong CHOI, Uijeongbu-si (KR); Ju-Young KIM, Tongyeong-si (KR); Dae-Hee SEO, Daejeon (KR); Seung-Hee OH, Daejeon (KR); Kwan-Tae CHO, Daejeon (KR); Sang-Woo LEE, Daejeon (KR); Jung-Chan NA, Daejeon (KR); Hyun-Sook CHO, Daejeon (KR)

(73) Assignee: ELECTRONICS AND TELECOMMUNICATIONS RESEARCH INSTITUTE, Daejeon (KR)

(21) Appl. No.: 14/630,683

(22) Filed: Feb. 25, 2015

(30) Foreign Application Priority Data
Feb. 27, 2014 (KR) 10-2014-0023405

(51) Int. Cl. G01S 13/91; G01C 21/00

(52) U.S. Cl. CPC G01S 13/91; G01C 21/00

(57) ABSTRACT

An apparatus and method for providing traffic control service are disclosed herein. The apparatus for providing traffic control service includes a multi-sensor fusion processing unit, an image object tracking and combination unit, and an information provision unit. The multi-sensor fusion processing unit generates the location information of a vessel by fusing radar information and automatic identification system (AIS) information together. The image object tracking and combination unit sets a detection area on a closed-circuit television (CCTV) image based on the information of the vessel, and detects the vessel by performing image processing within the set detection area. The information provision unit generates mapping display information based on the information of the vessel and the result of the detection achieved by performing the image processing, and displays the generated mapping display information within a CCTV screen, thereby providing traffic control service.

### CROSS-REFERENCE TO RELATED APPLICATION

This application claims the benefit of Korean Patent Application No. 10-2014-0023405, filed Feb. 27, 2014, which is hereby incorporated by reference herein in its entirety.

### BACKGROUND

1. Technical Field

The present disclosure relates generally to an apparatus and method for providing traffic control service and, more particularly, to an apparatus and method that, in a control system for controlling the traffic (navigation) of vessels or aircrafts, map a vessel location based on an electronic navigational chart to a vessel location on a closed-circuit television (CCTV) screen and then provide control service based on the result of the mapping.

2. Description of the Related Art

Conventional traffic control services use a method of providing traffic control service using radar information. For example, in this method, when a controller clicks a control screen, a CCTV camera is directed toward a corresponding location through only pan and tilt control and then traffic control is performed.

In another method of providing traffic control service, location information is transmitted to CCTV equipment based on only automatic identification system (AIS) location information and then the corresponding AIS location information is simply displayed at the mapped location information of the CCTV equipment on a CCTV image screen.

However, even in the case of an error in AIS location information itself or a vessel not equipped with an AIS, the method of combining AIS location information with an image is commonly used at a control center in spite of errors in some cases, because processing is relatively easily performed.

Still another method of providing control service is a method of providing an augmented reality image, in which navigation information based on an electronic navigational chart and the traffic information of another vessel are provided on an actual image in an augmented reality fashion, as in Korean Patent Application Publication No. 2011-0116842 entitled “Method of Displaying Electronic Navigational Chart Using Augmented Reality in Vessel Navigation System.”

According to the International Convention for the Safety of Life at Sea (SOLAS), a 300 or more-ton vessel basically sends AIS information, including Maritime Mobile Service Identity (MMSI) information enabling the automatic identification of a vessel, latitude and longitude coordinates and dynamic, and static information, to a control center, and thus the location of the vessel can be easily identified, thereby increasing the efficiency of traffic control.

However, in the case of AIS information, the reliability of the accuracy of an actual location is low because information may be non-uniform depending on the speed of movement and the difference in error may be significant depending on the precision of AIS equipment mounted in a vessel. Furthermore, when the AIS information is displayed on an image screen in the manner of performing overlaying on a CCTV screen based on such information, reliability is poor. Furthermore, in the case of a vessel that is not equipped with AIS equipment, a problem arises in that it is difficult to perform display on a CCTV screen because there is no corresponding information.

In connection with general CCTV equipment, research into a scheme for being independently installed and detecting and tracking an object using a signal processing function has been conducted based on a conventional image processing function. In other words, there are few attempts to improve accuracy through combination with another type of sensing equipment. In particular, there are few cases in which a combination method and a processing performance improvement method are attempted in a maritime control system.

### SUMMARY

At least some embodiments of the present invention are directed to the provision of an apparatus and method that, in a control system for controlling the traffic (navigation) of vessels or aircrafts, map a vessel location based on an electronic navigational chart to a vessel location on a CCTV screen and then provide control service based on the result of the mapping.

In accordance with an aspect of the present invention, there is provided a method of providing traffic control service, including acquiring the location information of a vessel by fusing radar information and automatic identification system (AIS) information together; checking whether coordinates corresponding to the location information of the vessel are present within a closed-circuit television (CCTV) screen coordinate range, and checking whether the vessel is a vessel having been previously tracked or a new vessel; if the vessel is a new vessel, generating mapping display information based on the location information of the vessel and port management information; and displaying the mapping display information at a mapping location within the CCTV screen coordinate range, and tracking the vessel based on vessel image processing.

Tracking the vessel may include, if the vessel is a vessel having been previously tracked, tracking the vessel based on vessel image processing.

Tracking the vessel based on vessel image processing may be performed using at least one of an object detection technique using a histogram, an object detection technique using inter-frame difference image data, a detection technique based on object learning, a detection technique using a Kalman filter for the prediction of the moving direction of an object, and a method based on a combination thereof.

Checking whether the vessel is a vessel having been tracked or a new vessel may include, if the coordinates corresponding to the location information of the vessel are present within the CCTV screen coordinate range, determining that the vessel is a vessel having been previously tracked, and, if the coordinates corresponding to the location information of the vessel are not present within the CCTV screen coordinate range, determining that the vessel is a new vessel.

The method may further include, if the coordinates corresponding to the location information of the vessel are not present within the CCTV screen coordinate range, displaying the coordinates corresponding to the location information of the vessel within the CCTV screen.

In accordance with another aspect of the present invention, there is provided an apparatus for providing traffic control service, including a multi-sensor fusion processing unit configured to generate the location information of a vessel by fusing radar information and AIS information together; an image object tracking and combination unit configured to set a detection area on a CCTV image based on the information of the vessel, and to detect the vessel by performing image processing within the set detection area; and an information provision unit configured to generate mapping display information based on the information of the vessel and the result of the detection achieved by performing the image processing, and to display the generated mapping display information within a CCTV screen, thereby providing traffic control service.

The image object tracking and combination unit may search for detailed information of the corresponding vessel based on the information of the vessel in a port management information storage unit.

The port management information storage unit may include the name of a vessel and specification information of the vessel with respect to each vessel, which are received from a port management information system (Port-MIS).

The image object tracking and combination unit, without continuously receiving the information of the vessel from the multi-sensor fusion processing unit, may detect the vessel through image processing while moving across a detection area set by itself, and may transmit the location, speed and direction information of the detected vessel to the information provision unit.

The image object tracking and combination unit may detect the vessel by performing the image processing using at least one of an object detection technique using a histogram, an object detection technique using inter-frame difference image data, a detection technique based on object learning, a detection technique using a Kalman filter for the prediction of the moving direction of an object, and a method based on a combination thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a control environment to which a general vessel traffic service (VTS) has been applied;

FIG. 2 is a diagram illustrating an environment to which an apparatus for providing traffic control service according to an embodiment of the present invention has been applied;

FIG. 3 is a diagram schematically illustrating the configuration of an apparatus for providing traffic control service according to an embodiment of the present invention; and

FIG. 4 is a flowchart illustrating a method of providing traffic control service according to an embodiment of the present invention.

### DETAILED DESCRIPTION

Embodiments of the present invention will be described in detail below with reference to the accompanying drawings. Repeated descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes, etc. of components in the drawings may be exaggerated to make the description obvious.

An apparatus and method for providing traffic control service according to embodiments of the present invention will be described in detail below with reference to the accompanying drawings.

First, in the present invention, during the navigation of a vessel or an aircraft, the signal information of the vessel or aircraft is fused with the information of a plurality of sensors, and information corresponding to the result of the fusion is transmitted to a CCTV optical device. Thereafter, in the present invention, the multi-sensor fusion (an image-based object detection and tracking processing algorithm) of the corresponding area of CCTV is processed, and information corresponding to the result of the processing is displayed on a CCTV screen, so that a vessel location based on an electronic navigational chart is appropriately mapped to a vessel location within a CCTV screen, thereby enabling a controller to appropriately determine the maritime situation of the vessel.

That is, in the present invention, found information about the movement of a vessel is accurately fused with existing image information in an imaging system, such as CCTV, thereby attempting to provide more accurate information.

Accordingly, when location information accurately estimated based on not only AIS information but also radar information is provided, the probability of error is reduced, and an image detection area is reduced. If an object recognition process is performed on image information once more, more accurate information can be provided.

Furthermore, rather than to simply display AIS information (for example, received AIS information including the name of a vessel, etc.) on a CCTV screen, the present invention is configured to display multi-sensor-based accurate information in which radar information and AIS information have been combined, other than AIS latitude and longitude coordinate information, to display information with vessel information (tonnage, and vessel information) received from a port management information system (hereinafter referred to as a “Port-MIS”) associated with real-time information, in addition to AIS information, and to display error (AIS information has its own error because an error may occur when a vessel is input; only English is available)-free information, with the result that controllers can be prevented from making determination errors attributable to a control system.

Although a radar transmission period is determined by the rotating speed of a radar, most of normal maritime traffic control radars provide information in periods of three seconds, i.e., an information provision period. This means that a normal maritime traffic control radar transmits location information to a control center at intervals of three seconds. Accordingly, even when information is not received from an AIS, the period of information in which AIS information and radar information have been combined can be basically maintained at intervals of three seconds.

Next, a process of tracking a target using a radar is described.

Basically, a process of tracking a target using a radar refers to a process of finding the moving characteristics of a corresponding target by analyzing information about a plurality of unspecified targets received by a radar transceiver and continuously tracking the moving situation of the corresponding target based on the moving characteristics of the corresponding target. This tracking process involves tracking errors, and thus a mathematical filter is used to minimize such errors. In this case, the mathematical filter is called a tracking filter, and such a processing algorithm is called a tracking algorithm. Furthermore, the tracking process is performed using a dynamic filtering technique based on the iterative prediction and updating of a tracking filter in real time. A Kalman filter is being used as a representative tracking filter.

In order to perform continuous tracking in the tracking process, a process of selecting an accurate target from among a plurality of targets is required. That is, since target tracking is performed in a situation where clutter or noise is present, a data association process of accurately distinguishing a genuine target from sensor measurement values from ambiguous sources, in addition to an actual target being currently tracked in order to perform accurate tracking.

After the data association process, the continuous track of each target is generated. In accordance with the number of targets, there is a plurality of generated tracks. This information is received from multiple radars rather than a single radar. Redundant tracks are eliminated through the mutual fusion of tracks generated by the multiple radars, and a fusion filter is used to increase the accuracy of a location.

A final location is selected by fusing combined information received from the multiple radars with GPS latitude and longitude coordinates received from an AIS, other than a radar, in an asynchronous manner and is then displayed on a screen, so that a controller views this and then issues a control command.

In the present invention, the filtering of AIS latitude and longitude coordinates is performed by detecting a jamming signal while receiving information from an AIS reception device. A target selected based on the result of the filtering has been aware of an error, and there is a need for a measure to enable a system to detect this and perform real-time processing in order not to perform fusion on such information.

Accordingly, there is a need for a scheme in which a next-generation control system or a monitoring system in a vessel or an aircraft detects a jamming signal, classifies the result of the detection according to the area, verifies and filters existing information and an error, do not apply information upon information fusion in a problematic jamming area, and notifies a controller of corresponding information in real time and also notifies a vessel in a corresponding maritime area of the information, thereby preventing the vessel from using the erroneous information in its navigation.

For this purpose, the present invention is configured to fuse the information of a plurality of sensors, such as a radar, in order to determine the path of a vessel during the navigation of the vessel, and to display the information on the monitor control screen of a maritime traffic control system. Furthermore, information displayed on the monitor control screen is transmitted to a CCTV optical device again, and the multi-sensor fusion in the corresponding area of the CCTV is processed (using an image-based object detection and tracking processing algorithm), and thus information is displayed at the accurate location of a vessel on a CCTV display screen. Information to be displayed includes accurate information received from not only an AIS but also a port management information system, and is then displayed on the CCTV display screen. That is, the present invention is intended to improve the accuracy of an electronic navigational chart-based vessel location and a location on CCTV, and to allow information (for example, the name of a vessel) to be appropriately mapped without error, thereby enabling a controller to accurately determine the maritime situation of a vessel.

The control screen of a control system is compared with a CCTV screen below.

Information into which radar information and AIS information have been fused is displayed on the control screen. In contrast, the CCTV screen is problematic in that the information of a vessel not equipped with an AIS is not displayed and in that a jumping phenomenon occurs because a time unit is based on a global positioning system and also a distance occurs when reception is performed after a specific period (for example, 6 seconds).

An AIS-based vessel name display CCTV that displays AIS information on a CCTV screen cannot display information even when a vessel not equipped with an AIS passes by a CCTV camera. Furthermore, with regard to the update period of the AIS, a phenomenon in which a displayed location jumps continuously and far occurs frequently due to inaccuracy attributable to the facts that the reception of AIS information itself is irregular due to the speed of movement of a vessel and is lost due to a mounted device. Moreover, a case where radar information and AIS information are transmitted and simply displayed on a CCTV screen through coordinate conversion in a simple overlaid manner without combination with an image object has the following problems. Although a location is adjusted when a CCTV camera is installed, an error in image coordinates increases due to sea wind and the passage of time, and thus location stability is degraded. Accordingly, information may appear in an area where there is no vessel image and thus generates an error. That is, the mechanical pan and tilt control error of the camera increases continuously. In this case, it is not easy to adjust a camera coordinate system again. Accordingly, there is a need for a method of acquiring fused image information through automatic image detection, other than a manual method.

Therefore, the present invention is intended to provide control service that provides fused image information acquired through the automatic detection of an image.

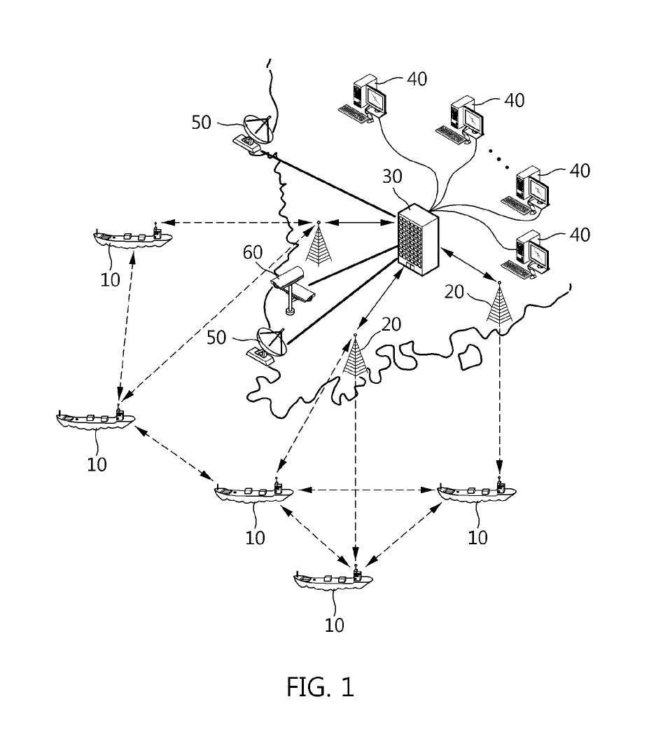

FIG. 1 is a diagram illustrating a control environment to which a general vessel traffic service (VTS) has been applied.

Referring to FIG. 1, in the control environment to which the general VTS has been applied, vessels 10, AIS base stations 20, a control center 30, control systems 40, radars 50 and closed-circuit television (CCTV) 60 are located.

The control center 30 may receive AIS messages from the vessels 10 via the AIS base stations 20, may acquire the location information of a target (vessel) from the radars 50, and may determine maritime information using the CCTV 60. Meanwhile, the control center 30 enables the information to be displayed via the control systems 40, and a controller performs control while monitoring the displayed information.

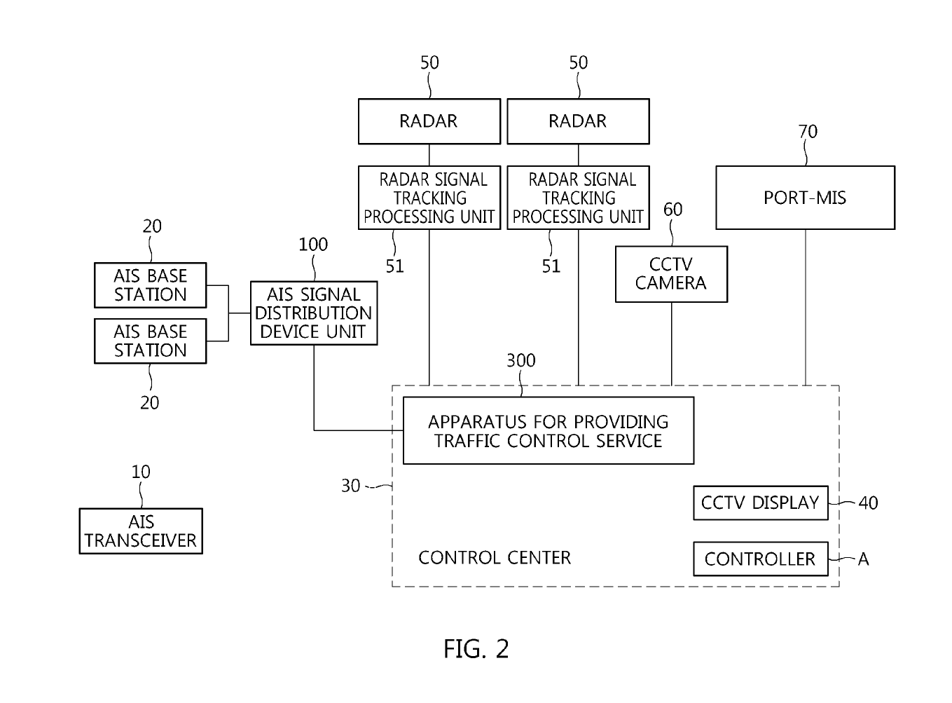

Next, an environment to which an apparatus 300 for providing control service according to an embodiment of the present invention has been applied is described in detail with reference to FIG. 2.

FIG. 2 is a diagram illustrating the environment to which the apparatus 300 for providing control service according to the present embodiment has been applied.

Referring to FIG. 2, in the environment to which the apparatus 300 for providing control service according to the present embodiment has been applied, an AIS transceiver 10, AIS base stations 20, an AIS signal distribution device unit 100, a control center 30, a CCTV display 40, radars 50, radar signal tracking processing units 51, a CCTV camera 60, and a Port-MIS 70 may be located. The environment is not limited thereto.

The AIS base stations 20 receive AIS information that is transmitted by a vessel equipped with the AIS transceiver 10.

The AIS signal distribution device unit 100 collects the AIS information received by the AIS base station 20, and distributes and transmits the collected AIS information to locations where the information is required, for example, the apparatus 300 for providing control service which is located in the control center 30.

The radar signal tracking processing unit 51 receives a radar signal, including the target information of a vessel, from the radar 50, eliminates noise from the received radar signal, and then generates the track of the vessel based on the noise-free signal. Then the radar signal tracking processing unit 51 transfers the generated track of the vessel to the apparatus 300 for providing control service.

The CCTV camera 60 transfers a CCTV image of a corresponding imaged area to the apparatus 300 for providing control service.

The Port-MIS 70 is a block that manages information required for the management of vessels, and includes the names of vessels, vessel specification information, etc.

The apparatus 300 for providing control service integrates the received information, calculates the location, speed, etc. of the corresponding vessel, and displays the corresponding location on the CCTV display 40, thereby providing more accurate control service.

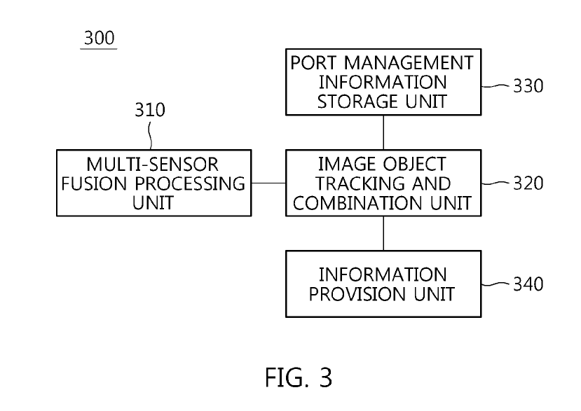

Next, an apparatus for providing traffic control service is described in detail with reference to FIG. 3.

FIG. 3 is a diagram schematically illustrating the configuration of an apparatus 300 for providing control service according to an embodiment of the present invention.

Referring to FIG. 3, the apparatus 300 for providing control service includes a multi-sensor fusion processing unit 310, an image object tracking and combination unit 320, a port management information storage unit 330, and an information provision unit 340.

The multi-sensor fusion processing unit 310 receives radar information and AIS information from the radar signal tracking processing units 51 and the AIS signal distribution device unit 100, and generates vessel information by fusing the received radar information and the AIS information together.

The image object tracking and combination unit 320 receives a CCTV image from the CCTV camera 60 in a continuous manner, and performs the data processing process of mapping the received CCTV image to display coordinates.

Then the image object tracking and combination unit 320 sets a detection area based on the vessel information received from the multi-sensor fusion processing unit 310. The detailed location of the vessel is tracked within the detection area by means of an object detection technique using a histogram, an object detection technique using inter-frame difference image data, a detection technique based on object learning, a detection technique using a Kalman filter for the prediction of the moving direction of an object, or a method based on a combination thereof.

The image object tracking and combination unit 320 searches the detailed information of the corresponding vessel in the port management information storage unit 330 based on the vessel information received from the multi-sensor fusion processing unit 310.

The image object tracking and combination unit 320 provides vessel information and the location, speed and direction information of the vessel to the CCTV display 40 based on the found location value of the results of the detection, and performs control so that the vessel information can be displayed at the corresponding location value on the CCTV display 40.

When the above-described display process is performed, the image object tracking and combination unit 320 according to an embodiment of the present invention, without continuously receiving the vessel information of the detected vessel from the multi-sensor fusion processing unit 310, detects a vessel through image processing while moving across a detection area set by itself, and transmits the location, speed and direction information of the detected vessel to the CCTV display 40, thereby allowing the information to be displayed.

When the vessel information received from the multi-sensor fusion processing unit 310 corresponds to information about a normally detected vessel being displayed on the CCTV display 40, the image object tracking and combination unit 320 continuously provides the method of performing image processing within a detection area if the difference with the displayed coordinates is smaller than a set reference. In contrast, if the difference with the displayed coordinates is equal to or larger than the set reference, the image object tracking and combination unit 320 resets a detection area based on location information corresponding to the received vessel information, and performs image processing within the reset detection area.

The port management information storage unit 330 includes port management information received from the Port-MIS 70. In this case, the port management information includes the name of a vessel, vessel specification information, etc. with respect to each vessel.

The information provision unit 340 generates mapping display information based on the result of the fusion of the radar information and the AIS information performed by the multi-sensor fusion processing unit 310 and the result of the image processing performed by the image object tracking and combination unit 320, and provides control service based on the generated mapping display information.

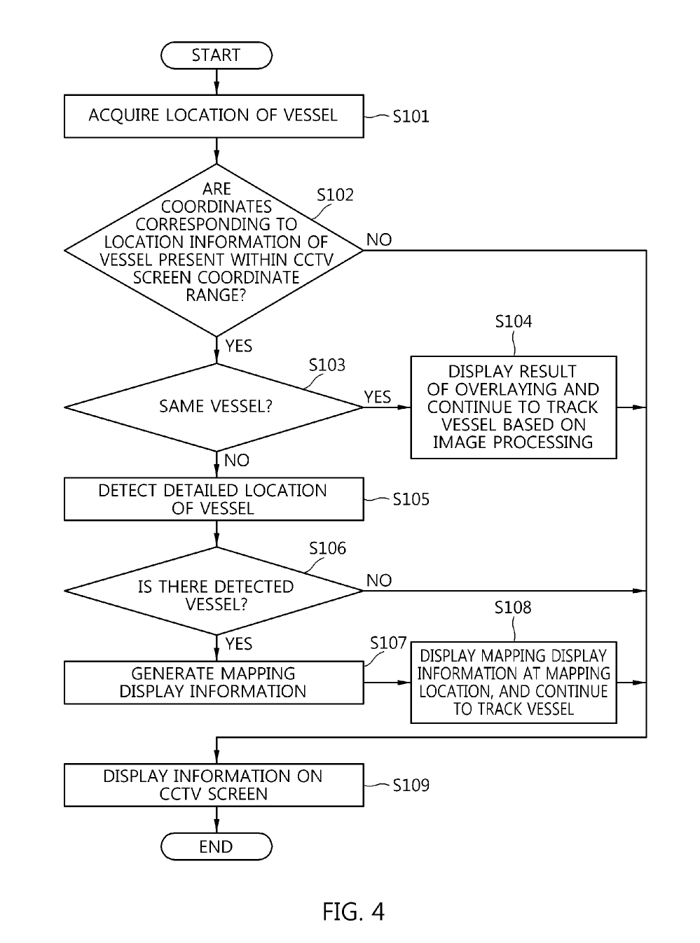

Next, a method in which the apparatus 300 for providing control service provides control service is described in detail with reference to FIG. 4.

FIG. 4 is a flowchart illustrating a method of providing traffic control service according to an embodiment of the present invention.

Referring to FIG. 4, the apparatus 300 for providing control service receives radar information and AIS information from the radar signal tracking processing unit 51 and the AIS signal distribution device unit 100, and acquires the location information of a vessel by fusing the received radar information and AIS information together at step S101.

The apparatus 300 for providing control service checks whether coordinates corresponding to the location information of a vessel clicked by a controller on an electronic navigational chart-based operation screen or the location information of a vessel acquired at step S101 are present in a CCTV screen coordinate range at step S102. In this case, the CCTV screen coordinate range corresponds to a detection area that is set based on vessel information generated through the fusion of the radar information and the AIS information by the apparatus 300 for providing control service.

In general, when a controller clicks the corresponding vessel on a control screen, i.e., an electronic navigational chart-based operation screen, tracking is started, and the CCTV is automatically directed toward the location of the corresponding vessel through pan and tilt control. Accordingly, the apparatus 300 for providing control service can acquire the location information of the corresponding vessel.

The apparatus 300 for providing control service tracks the detailed location of the vessel by means of an object detection technique using a histogram, an object detection technique using inter-frame difference image data, a detection technique based on object learning, a detection technique using a Kalman filter for the prediction of the moving direction of an object, or a method based on a combination thereof, and then checks whether coordinates corresponding to the location information of the vessel are present within a CCTV screen coordinate range.

If, as a result of the checking at step S102, it is determined that the coordinates corresponding to the location information of the vessel are present within the CCTV screen coordinate range, the apparatus 300 for providing control service checks whether the vessel having been tracked is the same as the vessel present within CCTV screen coordinate at step S103.

If the vessels are the same, the apparatus 300 for providing control service overlays vessel information corresponding to the result of the fusion of the radar information and the AIS information on the displayed coordinates of a CCTV image received from the CCTV camera 60, displays the result of the overlaying, and then continues to track the vessel based on image processing at step S104.

At step S105, if the vessels are not the same, the apparatus 300 for providing control service tracks the detailed location of the vessel within a reduced detection area, other than the overall image, based on the location information of the vessel acquired at step S101. In this case, the apparatus 300 for providing control service tracks the location of the vessel using a method of performing image processing within a detection area. The method of performing image processing within a detection area may be one of an object detection technique using a histogram, an object detection technique using inter-frame difference image data, a detection technique based on object learning, a detection technique using a Kalman filter for the prediction of the moving direction of an object, and a method based on a combination thereof.

At step S106, the apparatus 300 for providing control service checks whether there is a detected vessel as a result of the detection at step S105.

If there is a detected vessel, the apparatus 300 for providing control service generates mapping display information based on the result of the fusion of the radar information and the AIS information and port management information received from the Port-MIS 70 at step S107.

The apparatus 300 for providing control service displays the generated mapping display information at a mapping location and continues to track the vessel based on image processing at step S108.

At step S109, the apparatus 300 for providing control service provides a CCTV image to a user via the CCTV display 40 after steps S104 and S108 and if there is no detected vessel.

The present invention is configured to provide information in order to enable fusion information to be applied directly to an image display system, i.e., a CCTV display, and apply a tracking algorithm for performing image processing to the corresponding information, thereby reducing influence resulting from a mechanical error attributable to the shaking of CCTV itself, is configured to provide accurate location information to the CCTV display, thereby allowing the accurate location information to be used for traffic control, is configured to operate in conjunction with the Port-MIS, thereby providing better information, and is configured to directly notify a controller of results, thereby providing measures for performing recognition and determination in various situations.

Furthermore, the present invention is configured to be free from the errors of an image display system itself and errors attributable to special situations to some degree, thereby preventing the confusion of the control system and a controller, and is configured to present a differentiated algorithm and a systematic operation method, thereby reducing the level of risk and also ensuring the stability of the system, with the result that the present invention can be utilized in all control processors capable of stably processing traffic control.

As described above, the optimum embodiments have been disclosed in the drawings and the specification. Although specific terms have been used herein, they have been used merely for the purpose of describing the present invention, but have not been used to restrict their meanings or limit the scope of the present invention set forth in the claims. Accordingly, it will be understood by those having ordinary knowledge in the relevant technical field that various modifications and other equivalent embodiments can be made. Therefore, the true ranges of protection of the present invention should be defined based on the technical spirit of the attached claims.

What is claimed is:

1. A method of providing traffic control service, comprising:
acquiring location information of a vessel by fusing radar information and automatic identification system (AIS) information together;
checking whether coordinates corresponding to the location information of the vessel are present within a closed-circuit television (CCTV) screen coordinate range, and checking whether the vessel is a vessel having been previously tracked or a new vessel;
if the vessel is a new vessel, generating mapping display information based on the location information of the vessel and port management information; and
displaying the mapping display information at a mapping location within the CCTV screen coordinate range, and tracking the vessel based on vessel image processing.

2. The method of claim 1, wherein tracking the vessel comprises, if the vessel is a vessel having been previously tracked, tracking the vessel based on vessel image processing.

3. The method of claim 1, wherein tracking the vessel based on vessel image processing is performed using at least one of an object detection technique using a histogram, an object detection technique using inter-frame difference image data, a detection technique based on object learning, a detection technique using a Kalman filter for the prediction of the moving direction of an object, and a method based on a combination thereof.

4. The method of claim 1, wherein checking whether the vessel is a vessel having been tracked or a new vessel comprises, if the coordinates corresponding to the location information of the vessel are present within the CCTV screen coordinate range, determining that the vessel is a vessel having been previously tracked, and, if the coordinates corresponding to the location information of the vessel are not present within the CCTV screen coordinate range, determining that the vessel is a new vessel.

5. The method of claim 1, further comprising, if the coordinates corresponding to the location information of the vessel are not present within the CCTV screen coordinate range, displaying the coordinates corresponding to the location information of the vessel within the CCTV screen.

6. An apparatus for providing traffic control service, comprising:
a multi-sensor fusion processing unit configured to generate location information of a vessel by fusing radar information and AIS information together;
an image object tracking and combination unit configured to set a detection area on a CCTV image based on the information of the vessel, and to detect the vessel by performing image processing within the set detection area; and
an information provision unit configured to generate mapping display information based on the information of the vessel and a result of the detection achieved by performing the image processing, and to display the generated mapping display information within a CCTV screen, thereby providing traffic control service.

7. The apparatus of claim 6, wherein the image object tracking and combination unit searches for detailed information of the corresponding vessel based on the information of the vessel in a port management information storage unit.

8. The apparatus of claim 7, wherein the port management information storage unit comprises a name of a vessel and specification information of the vessel with respect to each vessel, which are received from a port management information system (Port-MIS).

9. The apparatus of claim 6, wherein the image object tracking and combination unit, without continuously receiving the information of the vessel from the multi-sensor fusion processing unit, detects the vessel through image processing while moving across a detection area set by itself, and transmits location, speed and direction information of the detected vessel to the information provision unit.

10. The apparatus of claim 6, wherein the image object tracking and combination unit detects the vessel by performing the image processing using at least one of an object detection technique using a histogram, an object detection technique using inter-frame difference image data, a detection technique based on object learning, a detection technique using a Kalman filter for the prediction of the moving direction of an object, and a method based on a combination thereof.
